(19) United States
(12) Patent Application Publication
(10) Pub. No.: US 2024/0418946 A1
(43) Pub. Date: Dec. 19, 2024

(54) LIGHT EMITTING DEVICE, SYSTEM, AND METHOD

(71) Applicants: The Trustees of Princeton University, Princeton, NJ (US); Universal Display Corporation, Ewing, NJ (US)

(72) Inventors: Simon Bilodeau, Princeton, NJ (US); Michael Hack, Carmel, CA (US); Paul Prucnal, Princeton, NJ (US); Eli A. Doris, Princeton, NJ (US); Michael S. Weaver, Ewing, NJ (US)

(21) Appl. No.: 18/678,654

(22) Filed: May 30, 2024

Related U.S. Application Data
(60) Provisional application No. 63/508,074, filed on Jun. 14, 2023.
(60) Provisional application No. 63/514,832, filed on Jul. 21, 2023.

(51) Int. Cl. G02B 6/42

(52) U.S. Cl. CPC G02B 6/4206

(57) ABSTRACT

A light emitting device comprises a waveguide, a downconverting thin-film stack in optical communication with the waveguide, and an OLED thin-film stack in optical communication with the downconverting thin-film stack. An integrated photonic system comprises the downconverted as described above, wherein the downconverted OLED stack is integrated with a silicon photonic chip or CMOS photonic chip. A method for providing pump light for a silicon photonic integrated circuit comprises providing the integrated photonic as described above, producing light via the OLED thin-film stack; downconverting the produced light via the downconverting thin-film stack, and guiding the downconverted light via the waveguide.

### CROSS-REFERENCE TO RELATED APPLICATIONS

This application claims priority to U.S. provisional application No. 63/508,074 filed on Jun. 14, 2023, and to U.S. provisional application No. 63/514,832 filed on Jul. 21, 2023, each of which is incorporated herein by reference in its entirety.

### BACKGROUND OF THE INVENTION

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety. One application for phosphorescent emissive molecules is a full color display. Industry standards for such a display call for pixels adapted to emit particular colors, referred to as “saturated” colors. In particular, these standards call for saturated red, green, and blue pixels. Color may be measured using CIE coordinates, which are well known to the art.

Silicon is a widely-used platform for integrated photonic systems, mostly due to the maturity and silicon microfabrication inherited from electronics. This is remarkable given that efficient silicon light sources do not exist. To overcome this, separate expensive III-V semiconductor chips are usually cointegrated with the silicon chips solely to provide a light source feeding into the silicon, with silicon handling all other photonic functionality (guiding, filtering, modulation, detection, and even electronics in some specialized platforms). While the III-V chips provide high performance lasers, they are expensive, and they cannot be directly integrated onto the silicon, which prohibits scaling of silicon photonic circuits to a large number of light sources, and adds unnecessary size and cost to such a system.

Silicon photonics is an emerging technology that uses silicon-based components to manipulate and transmit light instead of electrons. In the data center market, silicon photonics technology is primarily used for high-speed optical interconnects between servers, switches, and other networking equipment. According to reports, the global data center interconnect market was valued at USD 7.1 billion in 2020, and is expected to reach USD 14.8 billion by 2025, at a CAGR of 15.8% during the forecast period. This is enabled by the technology's compatibility with existing silicon manufacturing processes, which makes it cost-effective and scalable. The rising maturity of this technology is further driving applications in sensing, neuromorphic computing, and quantum computing.

### SUMMARY OF THE INVENTION

Some embodiments of the invention disclosed herein are set forth below, and any combination of these embodiments (or portions thereof) may be made to define another embodiment.

In one aspect, a light emitting device comprises a waveguide, a downconverting thin-film stack in optical communication with the waveguide, and an OLED thin-film stack in optical communication with the downconverting thin-film stack.

In one embodiment, the device is configured as an on-chip light source for a silicon photonic integrated circuit.

In one embodiment, the device further comprises a bottom cladding layer or stack below the waveguide, and a top cladding layer or stack above the waveguide and bottom cladding layer, and surrounding at least two sides of the downconverting and OLED thin-film stacks.

In one embodiment, the device further comprises a metal layer on one side of the OLED thin-film stack.

In one embodiment, the metal layer is configured to reflect light from the OLED thin-film stack to the downconverting thin-film stack.

In one embodiment, the metal layer encapsulates at least three sides of the OLED thin-film stack.

In one embodiment, the waveguide comprises a first portion comprising a first material, and a second portion comprising a second material.

In one embodiment, the first material comprises a polymer and the second material comprises silicon.

In one embodiment, the index of refraction of the first material is smaller than the index of refraction of the second material.

In one embodiment, the first portion of the waveguide is at least partially tapered in the vertical direction.

In one embodiment, the second portion of the waveguide is not tapered in the vertical direction.

In one embodiment, the device further comprises a metal layer positioned above and encapsulating at least three sides of the OLED thin-film stack, wherein the metal layer is positioned above and encapsulating a non-vertically tapered section of the first portion of the waveguide, a vertically tapered section of the first portion of the waveguide, and at least one vertical side of the first portion of the waveguide, and wherein the top metal layer is positioned above a section of the second portion of the waveguide.

In one embodiment, the metal layer is in contact with the vertically tapered section of the first portion of the waveguide and with the section of the second portion of the waveguide.

In one embodiment, the device further comprises a metal layer comprising a top portion, at least one side portion, and a bottom portion, wherein the top portion of the metal layer is positioned above and encapsulating at least three sides of the OLED thin-film stack, wherein the top portion of the metal layer is positioned above a non-vertically tapered section of the first portion of the waveguide, and a vertically tapered section of the first portion of the waveguide, wherein the side portion of the metal layer encapsulates at least one vertical side of the first portion of the waveguide, and wherein the top portion of the metal layer is positioned above a section of the second portion of the waveguide.

In one embodiment, wherein the top portion of the metal layer is positioned above a non-vertically tapered section of the second portion of the waveguide.

In one embodiment, the bottom portion of the metal layer is between the first part of the waveguide and a bottom cladding layer.

In one embodiment, the bottom portion of the metal layer is adjacent to the second portion of the waveguide.

In one embodiment, the device has an optical efficiency of at least 25%.

In one embodiment, wherein the downconverting thin-film stack is configured to down convert light from the OLED thin-film stack to a wavelength in the range of 1100 nm to 2400 nm.

In one embodiment, the OLED thin-film stack is configured to produce light in a wavelength range of 400 nm to 800 nm.

In one embodiment, the waveguide comprises a first and third portions comprising a first material, and a second portion comprising a second material and between the first and third portions.

In one embodiment, the first material comprises a polymer and the second material comprises silicon.

In one embodiment, the index of refraction of the first material is smaller than the index of refraction of the second material.

In one embodiment, the second portion of the waveguide is vertically tapered in a first section, and vertically tapered in a second section opposite the first section.

In one embodiment, at least one of the first portion and the third portion of the waveguide includes a reflector stack.

In one embodiment, the device further comprises a metal layer positioned above and encapsulating at least three sides of the OLED thin-film stack, wherein top metal layer is positioned above and encapsulating a majority of the second portion of the waveguide including the tapered first and third sections, and wherein the metal layer is positioned above sections of the first and third portions of the waveguide.

In one embodiment, the first portion of the waveguide is configured to receive light from a laser.

In another aspect, a product comprises the light emitting device as described above, where the product selected from the group consisting of a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a sign, a full-stack optical platform, an optical interconnect, a high-speed optical interconnect, a MEMS device, an optical amplifier, an optical driver, a neuromorphic computer, a quantum computer, and/or a sensing device.

In another aspect, an integrated photonic system comprises a downconverted OLED device comprising a waveguide, a downconverting thin-film stack in optical communication with the waveguide, and an OLED thin-film stack in optical communication with the downconverting thin-film stack, wherein the downconverted OLED stack is integrated with a silicon photonic chip or CMOS photonic chip.

In one embodiment, the system further comprises a laser in optical communication with the waveguide.

In another aspect, a method for providing pump light for a silicon photonic integrated circuit comprises providing an integrated photonic system comprising a downconverted OLED stack comprising a waveguide, a downconverting thin-film stack in optical communication with the waveguide, and an OLED thin-film stack in optical communication with the downconverting thin-film stack, wherein the downconverted OLED stack is integrated with a silicon photonic chip or CMOS photonic chip, producing light via the OLED thin-film stack, downconverting the produced light via the downconverting thin-film stack, and guiding the downconverted light via the waveguide.

In one embodiment, the method further comprises amplifying light received from a laser.

In another aspect, a light emitting device comprises a waveguide with embedded downconversion materials, and an OLED thin-film stack in optical communication with the waveguide.

In another aspect, a light emitting device comprises a waveguide, and an OLED thin-film stack in optical communication with the waveguide, wherein the device is configured as an on-chip light source for a silicon photonic integrated circuit.

In one embodiment, the metal layer is configured to reflect light from the OLED thin-film stack to the downconverting thin-film stack.

In one embodiment, the metal layer encapsulates at least three sides of the OLED thin-film stack.

In one embodiment, the waveguide comprises a first portion comprising a first material, and a second portion comprising a second material.

In one embodiment, the first material comprises a polymer and the second material comprises silicon.

In one embodiment, the index of refraction of the first material is smaller than the index of refraction of the second material.

In one embodiment, the device further comprises a metal layer on at least one side of the OLED thin-film stack.

In one embodiment, the OLED thin-film stack is over the waveguide

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 depicts an organic light emitting device in accordance with some embodiments.

FIG. 2 depicts an inverted organic light emitting device that does not have a separate electron transport layer in accordance with some embodiments.

FIG. 3 depicts an exemplary light emitting device in accordance with some embodiments.

FIG. 4 depicts an exemplary light emitting including a metal layer in accordance with some embodiments.

FIG. 5 depicts an exemplary light emitting device including a waveguide with first and second portions in accordance with some embodiments.

FIG. 6 depicts an exemplary light emitting device including a metal layer and a waveguide with first and second portions in accordance with some embodiments.

FIG. 7 depicts an exemplary light emitting device including an encapsulating metal layer and a waveguide with first and second portions in accordance with some embodiments.

FIG. 8 depicts an exemplary light emitting device including a waveguide with first, second, and third portions in accordance with some embodiments.

FIG. 9 depicts an exemplary light emitting device including a waveguide with first, second, and third portions, and a reflector in accordance with some embodiments.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in light emitting devices, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, +10%, +5%, +1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein are light emitting devices, systems, and methods.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

A ligand may be referred to as “photoactive” when it is believed that the ligand directly contributes to the photoactive properties of an emissive material. A ligand may be referred to as “ancillary” when it is believed that the ligand does not contribute to the photoactive properties of an emissive material, although an ancillary ligand may alter the properties of a photoactive ligand.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

As used herein, and as would be generally understood by one skilled in the art, on a conventional energy level diagram, with the vacuum level at the top, a “shallower” energy level appears higher, or closer to the top, of such a diagram than a “deeper” energy level, which appears lower, or closer to the bottom.

As used herein, and as would be generally understood by one skilled in the art, a first work function is “greater than” or “higher than” a second work function if the first work function has a higher absolute value. Because work functions are generally measured as negative numbers relative to vacuum level, this means that a “higher” work function is more negative. On a conventional energy level diagram, with the vacuum level at the top, a “higher” work function is illustrated as further away from the vacuum level in the downward direction. Thus, the definitions of HOMO and LUMO energy levels follow a different convention than work functions.

As used herein, and as would be generally understood by one skilled in the art, “thin-film stack” and/or “stack” may refer to a single layer or multiple layer architecture.

More details on OLEDs, and the definitions described above, can be found in U.S. Pat. No. 7,279,704, which is incorporated herein by reference in its entirety.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence is described in more detail in U.S. Pat. No. 7,279,704 at cols. 5-6, which are incorporated by reference.

Silicon itself is a highly versatile electric and optical material. Besides being the material of choice for most electronic chips used in electronic devices, it is transparent in the near-infrared, with a large index contrast to silicon dioxide to form compact photonic structures. It exhibits a strong native thermo-optic effect for reconfiguration. It presents electrorefractive effects for native GHz-speed modulation. It is easy to integrate with germanium to implement high-speed integrated photodetectors. This is in addition to it leveraging silicon processing, which offers many other avenues to integrate various other optical and electrical components and devices (MEMs, drivers, amplifiers, etc.).

What is lacking from this list, however, is a compatible light source as silicon itself does not readily emit light. Integration of light sources onto silicon is an active research area, and the state-of-the-art in industry is co-packaging of a separate III-V laser die near the silicon chip to provide the pump light used in the photonic circuit. This is due to the fact that direct integration of III-Vs on silicon is difficult as a result of lattice mismatch between the materials. While a separate die allows the light source to be high-quality, it significantly increases packaging complexity (and hence cost) and restricts the number of independent light sources that can be incorporated. The need for a separate die for the light source increases the size and footprint of Photonic Integrated Circuits (PICs), and requires more constraining external coupling schemes to be considered. A light source that could be processed directly on the silicon photonic chip, or even directly on the silicon waveguides, would greatly simplify these systems.

Organic light-emitting diodes (OLEDs) exploit the electroluminescence of organic molecules and polymers to create efficient, albeit incoherent (not laser-like), light sources. They have found commercial success in displays, where the thin-film processing compatibility of the OLEDs allows them to be processed at low cost on large areas. Namely, their integration and deposition on processed silicon substrates has already been industrially proven, for example through the advent of OLED microdisplays.

In telecommunications, wavelengths of interest extend between 1260 nm and 1625 nm, subdivided into different “bands” with varying properties of interest. Silicon itself becomes transparent around 1200 nm. The HOMO-LUMO gap of many electroluminescent organic molecules results in visible-band (400-700 nm) emission, and hence is not directly compatible with these ranges. While OLEDs generally emit visible light in the range of 400 nm to 800 nm OLEDs have also been reported to emit light into the near infra-red such as 700 to 900 nm. Down-conversion materials such as colloidal quantum dot films and phosphor films can, however, produce near-infrared photons from visible photons. In some embodiments as disclosed herein is a device and system that uses OLEDs as a light source, and then a downconversion medium is used to produce light of the required wavelength for optical processing in a photonic integrated circuit.

Disclosed herein are devices that integrate downconverted OLED stacks onto silicon photonic (or CMOS-photonic) chips as an easily-processed, inexpensive, large-area-patternable light source. This has the potential to address silicon's main shortcoming as an optical platform.

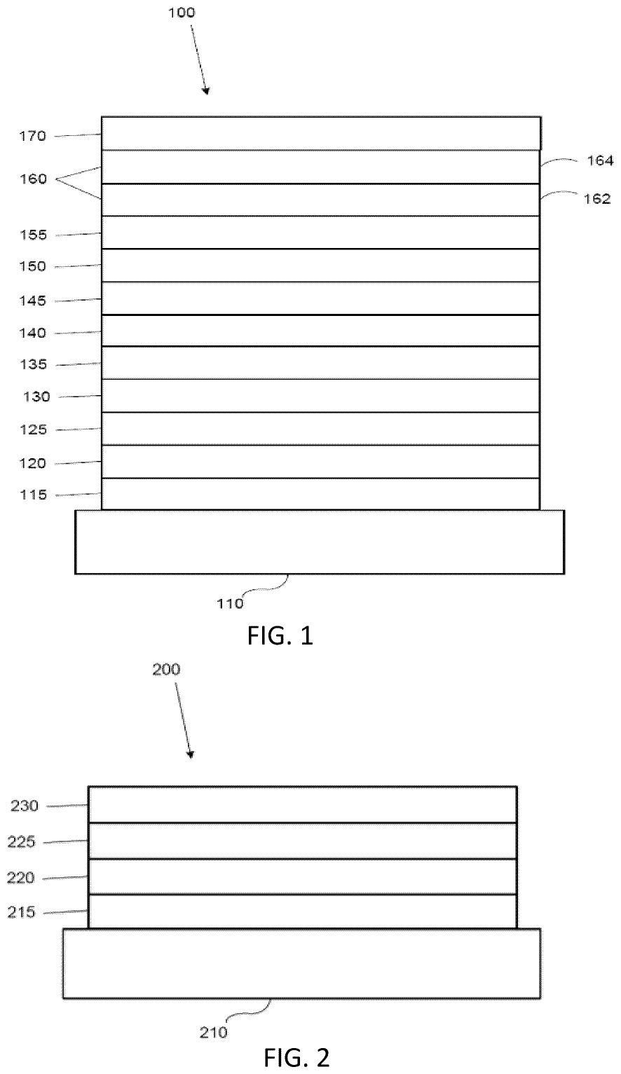

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, a cathode 160, and a barrier layer 170. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F₄-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. A description of protective layers may be found in U.S. Patent Application Publication No. 2004/0174116, which is incorporated by reference in its entirety.

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the disclosure may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. Pat. No. 7,431,968, which is incorporated by reference in its entirety. Other suitable deposition methods include spin coating and other solution-based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as inkjet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processability than those having symmetric structures, because asymmetric materials may have a lower tendency to recrystallize. Dendrimer substituents may be used to enhance the ability of small molecules to undergo solution processing.

Devices fabricated in accordance with embodiments of the present disclosure may further optionally comprise a barrier layer. One purpose of the barrier layer is to protect the electrodes and organic layers from damaging exposure to harmful species in the environment including moisture, vapor and/or gases, etc. The barrier layer may be deposited over, under or next to a substrate, an electrode, or over any other parts of a device including an edge. The barrier layer may comprise a single layer, or multiple layers. The barrier layer may be formed by various known chemical vapor deposition techniques and may include compositions having a single phase as well as compositions having multiple phases. Any suitable material or combination of materials may be used for the barrier layer. The barrier layer may incorporate an inorganic or an organic compound or both. The preferred barrier layer comprises a mixture of a polymeric material and a non-polymeric material as described in U.S. Pat. No. 7,968,146, PCT Pat. Application Nos. PCT/US2007/023098 and PCT/US2009/042829, which are herein incorporated by reference in their entireties. To be considered a “mixture”, the aforesaid polymeric and non-polymeric materials comprising the barrier layer should be deposited under the same reaction conditions and/or at the same time. The weight ratio of polymeric to non-polymeric material may be in the range of 95:5 to 5:95. The polymeric material and the non-polymeric material may be created from the same precursor material. In one example, the mixture of a polymeric material and a non-polymeric material consists essentially of polymeric silicon and inorganic silicon.

Devices fabricated in accordance with embodiments of the disclosure can be incorporated into a wide variety of electronic component modules (or units) that can be incorporated into a variety of electronic products or intermediate components. Examples of such electronic products or intermediate components include display screens, lighting devices such as discrete light source devices or lighting panels, etc. that can be utilized by the end-user product manufacturers, and cameras or other devices including optical or other sensors. Such electronic component modules can optionally include the driving electronics and/or power source(s). Devices fabricated in accordance with embodiments of the disclosure can be incorporated into a wide variety of consumer products that have one or more of the electronic component modules (or units) incorporated therein. A consumer product comprising an OLED that includes the compound of the present disclosure in the organic layer in the OLED is disclosed. Such consumer products would include any kind of products that include one or more light source(s) and/or one or more of some type of visual displays. Some examples of such consumer products include flat panel displays, curved displays, computer monitors, medical monitors, televisions, billboards, lights for interior or exterior illumination and/or signaling, heads-up displays, fully or partially transparent displays, flexible displays, rollable displays, foldable displays, stretchable displays, laser printers, telephones, mobile phones, tablets, phablets, personal digital assistants (PDAs), wearable devices, laptop computers, digital cameras, camcorders, viewfinders, other imaging devices, micro-displays (displays that are less than 2 inches diagonal), 3-D displays, virtual reality or augmented reality displays, vehicles, video walls comprising multiple displays tiled together, theater or stadium screen, and a sign, a full-stack optical platform, an optical interconnect, a high-speed optical interconnect, a MEMS device, an optical amplifier, an optical driver, a neuromorphic computer, a quantum computer, and a sensing device. Various control mechanisms may be used to control devices fabricated in accordance with the present disclosure, including passive matrix and active matrix. Many of the devices are intended for use in a temperature range comfortable to humans, such as 18 C to 30 C, and more preferably at room temperature (20-25 C), but could be used outside this temperature range, for example, from −40 C to 80 C.

Although exemplary embodiments described herein may be presented as methods for producing particular circuits or devices, for example OLEDs, it is understood that the materials and structures described herein may have applications in devices other than OLEDs. For example, other optoelectronic devices such as organic solar cells and organic photodetectors may employ the materials and structures. More generally, organic devices, such as organic transistors, or other organic electronic circuits or components, may employ the materials and structures.

In some embodiments, the OLED has one or more characteristics selected from the group consisting of being flexible, being rollable, being foldable, being stretchable, and being curved. In some embodiments, the OLED is transparent or semi-transparent. In some embodiments, the OLED further comprises a layer comprising carbon nanotubes.

In some embodiments, the OLED further comprises a layer comprising a fluorescent emitter, a delayed fluorescent emitter, a phosphorescent emitter, a hyperfluorescence emitter, a thermally assisted delayed fluorescent emitter (TADF) or a phosphorescent sensitized fluorescent emitter. In some embodiments, the OLED comprises a plasmonic OLED. In some embodiments, the OLED comprises a RGB pixel arrangement or white plus color filter pixel arrangement. In some embodiments, the OLED is a mobile device, a handheld device, or a wearable device. In some embodiments, the OLED is a display panel having less than 10 inch diagonal or 50 square inch area. In some embodiments, the OLED is a display panel having at least 10 inch diagonal or 50 square inch area. In some embodiments, the OLED is a lighting panel.

In some embodiments of the emissive region, the emissive region further comprises a host. In some embodiments, the compound can be an emissive dopant. In some embodiments, the compound can produce emissions via phosphorescence, fluorescence, thermally activated delayed fluorescence, i.e., TADF (also referred to as E-type delayed fluorescence; see, e.g., U.S. application Ser. No. 15/700,352, which is hereby incorporated by reference in its entirety), triplet-triplet annihilation, or combinations of these processes.

The OLED disclosed herein can be incorporated into one or more of a consumer product, an electronic component module, and a lighting panel or an imaging device. The organic layer can be an emissive layer and the compound can be an emissive dopant in some embodiments, while the compound can be a non-emissive dopant in other embodiments.

The organic layer can also include a host. In some embodiments, two or more hosts are preferred. In some embodiments, the hosts used maybe a) bipolar, b) electron transporting, c) hole transporting or d) wide band gap materials that play little role in charge transport. In some embodiments, the host can include a metal complex. The host can be an inorganic compound.

One aspect of the disclosure improves upon one or more techniques based on a re-entrant shadow mask disclosed in U.S. Pat. No. 6,013,538 issued on Jan. 11, 2000 to Burrows et al., the contents of which is incorporated herein by reference in its entirety.

In some embodiments, at least one of the anode, the cathode, or a new layer disposed over the organic emissive layer functions as an enhancement layer. The enhancement layer comprises a plasmonic material exhibiting surface plasmon resonance that non-radiatively couples to the emitter material and transfers excited state energy from the emitter material to non-radiative mode of surface plasmon polariton. The enhancement layer is provided no more than a threshold distance away from the organic emissive layer, wherein the emitter material has a total non-radiative decay rate constant and a total radiative decay rate constant due to the presence of the enhancement layer and the threshold distance is where the total non-radiative decay rate constant is equal to the total radiative decay rate constant. In some embodiments, the OLED further comprises an outcoupling layer. In some embodiments, the outcoupling layer is disposed over the enhancement layer on the opposite side of the organic emissive layer. In some embodiments, the outcoupling layer is disposed on opposite side of the emissive layer from the enhancement layer but still outcouples energy from the surface plasmon mode of the enhancement layer. The outcoupling layer scatters the energy from the surface plasmon polaritons. In some embodiments this energy is scattered as photons to free space. In other embodiments, the energy is scattered from the surface plasmon mode into other modes of the device such as but not limited to the organic waveguide mode, the substrate mode, or another waveguiding mode. If energy is scattered to the non-free space mode of the OLED other outcoupling schemes could be incorporated to extract that energy to free space. In some embodiments, one or more intervening layer can be disposed between the enhancement layer and the outcoupling layer. The examples for intervening layer(s) can be dielectric materials, including organic, inorganic, perovskites, oxides, and may include stacks and/or mixtures of these materials.

The enhancement layer modifies the effective properties of the medium in which the emitter material resides resulting in any or all of the following: a decreased rate of emission, a modification of emission line-shape, a change in emission intensity with angle, a change in the stability of the emitter material, a change in the efficiency of the OLED, and reduced efficiency roll-off of the OLED device. Placement of the enhancement layer on the cathode side, anode side, or on both sides results in OLED devices which take advantage of any of the above-mentioned effects. In addition to the specific functional layers mentioned herein and illustrated in the various OLED examples shown in the figures, the OLEDs according to the present disclosure may include any of the other functional layers often found in OLEDs.

The enhancement layer can be comprised of plasmonic materials, optically active metamaterials, or hyperbolic metamaterials. As used herein, a plasmonic material is a material in which the real part of the dielectric constant crosses zero in the visible or ultraviolet region of the electromagnetic spectrum. In some embodiments, the plasmonic material includes at least one metal. In such embodiments the metal may include at least one of Ag, Al, Au, Ir, Pt, Ni, Cu, W, Ta, Fe, Cr, Mg, Ga, Rh, Ti, Ru, Pd, In, Bi, Ca alloys or mixtures of these materials, and stacks of these materials. In general, a metamaterial is a medium composed of different materials where the medium as a whole acts differently than the sum of its material parts. In particular, optically active metamaterials are defined as materials which have both negative permittivity and negative permeability. Hyperbolic metamaterials, on the other hand, are anisotropic media in which the permittivity or permeability are of different sign for different spatial directions. Optically active metamaterials and hyperbolic metamaterials are strictly distinguished from many other photonic structures such as Distributed Bragg Reflectors (“DBRs”) in that the medium should appear uniform in the direction of propagation on the length scale of the wavelength of light. Using terminology that one skilled in the art can understand: the dielectric constant of the metamaterials in the direction of propagation can be described with the effective medium approximation. Plasmonic materials and metamaterials provide methods for controlling the propagation of light that can enhance OLED performance in a number of ways.

In some embodiments, the enhancement layer is provided as a planar layer. In other embodiments, the enhancement layer has wavelength-sized features that are arranged periodically, quasi-periodically, or randomly, or sub-wavelength-sized features that are arranged periodically, quasi-periodically, or randomly. In some embodiments, the wavelength-sized features and the sub-wavelength-sized features have sharp edges.

In some embodiments, the outcoupling layer has wavelength-sized features that are arranged periodically, quasi-periodically, or randomly, or sub-wavelength-sized features that are arranged periodically, quasi-periodically, or randomly. In some embodiments, the outcoupling layer may be composed of a plurality of nanoparticles and in other embodiments the outcoupling layer is composed of a plurality of nanoparticles disposed over a material. In these embodiments the outcoupling may be tunable by at least one of varying a size of the plurality of nanoparticles, varying a shape of the plurality of nanoparticles, changing a material of the plurality of nanoparticles, adjusting a thickness of the material, changing the refractive index of the material or an additional layer disposed on the plurality of nanoparticles, varying a thickness of the enhancement layer, and/or varying the material of the enhancement layer. The plurality of nanoparticles of the device may be formed from at least one of metal, dielectric material, semiconductor materials, an alloy of metal, a mixture of dielectric materials, a stack or layering of one or more materials, and/or a core of one type of material and that is coated with a shell of a different type of material. In some embodiments, the outcoupling layer is composed of at least metal nanoparticles wherein the metal is selected from the group consisting of Ag, Al, Au, Ir, Pt, Ni, Cu, W, Ta, Fe, Cr, Mg, Ga, Rh, Ti, Ru, Pd, In, Bi, Ca, alloys or mixtures of these materials, and stacks of these materials. The plurality of nanoparticles may have additional layer disposed over them. In some embodiments, the polarization of the emission can be tuned using the outcoupling layer. Varying the dimensionality and periodicity of the outcoupling layer can select a type of polarization that is preferentially outcoupled to air. In some embodiments the outcoupling layer also acts as an electrode of the device.

The terms “photosensitive element” and “photoresponsive element” as used in this disclosure refer to any electronic device whose electrical properties change in response to light. Examples of photosensitive elements include, but are not limited to, photodetectors, photodiodes, phototransistors, or photogates. Various exemplary embodiments of devices or systems may be presented herein including one or more particular photosensitive elements, for example photodetectors. These exemplary embodiments are not limiting, and that, as would be understood by one skilled in the art, any photosensitive element in an exemplary device may be substituted, sometimes with the addition or subtraction of additional circuitry, with another photosensitive element.

In some aspects of the present invention, a mirror and/or optical filtering device can include one or multiple layers of thin-films whose concerted action reflects some incident light, transmits some incident light, and (potentially) absorbs some incident some light. The amount of transmission, reflection, and absorption depends on the wavelength of light in general and is dictated by the filter design. Examples include but are not limited to metals, dielectric interfaces, quarter-wave stacks, rugate filters, graded-index filters, irregular discrete thin-film dielectric, optical resonators, multi-cavity optical resonators.

In some embodiments, the disclosed device provides a novel way to provide pump light for silicon photonic integrated circuits. In some embodiments, the disclosed device and system provides for a low cost, large area solution to on-chip silicon photonic light sources. In some embodiments, the disclosed device and system leverages the additive nature of organic and quantum dot thin-films to define a light source directly onto a silicon photonic integrated circuit. This addresses silicon's main shortcoming as an optical platform, keeping everything else that makes it great intact. It also enables a low-cost option to generate photons that can be used by the silicon chip to perform various communication, computing, and sensing tasks. In some embodiments, the disclosed device is manufactured by various standard microfabrication and thin-film processes (spin coating, deposition, etc.). Furthermore, the disclosed device and system address silicon's main shortcoming as a full-stack optical platform.

While at first glance there may appear to be possible disadvantages or limitations of the using downconverted OLEDs as a light source compared to typical single-mode laser solutions used such as incoherence of the emitted light, larger source linewidths, lower directionality of the emission, lower usable optical powers achievable due to the previous points, in addition to inefficiencies in the downconversion process and lower current densities supported, and low direct modulation bandwidth of the source the disclosed device does not encounter these above disadvantages or limitations.

While infrared light, particularly in the optical C and O bands, is useful for communication applications due to native compatibility with the world's existing communications infrastructure, a growing foundry ecosystem for silicon nitride PICs and the rise of additional applications have made visible-light photonics increasingly attractive over time. To this end, additional embodiments that omit the downconversion (VIS to IR) layer are also of interest.

Bio-photonics is one space that is opened up by visible light photonics due to the fact that many biological tissues have interesting spectral features in the visible band and many chromophores used in imaging have absorption and/or emission features in the visible band. New applications include, but are not limited to, imaging, diagnostics, monitoring, and spectroscopy. Applications that are traditionally best suited to infrared photonics (e.g., communications) are potentially also viable in the visible given a novel light source such as that disclosed herein. Although core components such as photodetectors, modulators, and switches are currently most optimized for the optical C and O bands, the availability of low-cost and small-size light sources in the visible could outweigh the penalties in performance in system components that comes with switching to the visible band.

For example, the incoherence of the emitted light can be made irrelevant by considering applications where well-defined phase of light is not required, for instance amplitude-modulated optical links and sensors. Larger source linewidths can be improved by narrowing the source emission, for instance either with highly efficient narrow linewidth phosphorescent emitters or with microcavity designs, or by adding spectral filters downstream of emission (at the cost of lower power efficiency). Lower directionality of the emission and lower usable optical powers achievable due to the previous points can be improved by designing optical coupling structures with wider light collection angles and broader spectrum in the silicon. Furthermore, low direct modulation bandwidth of the source is not a factor due to the presence in silicon of fast modulation techniques.

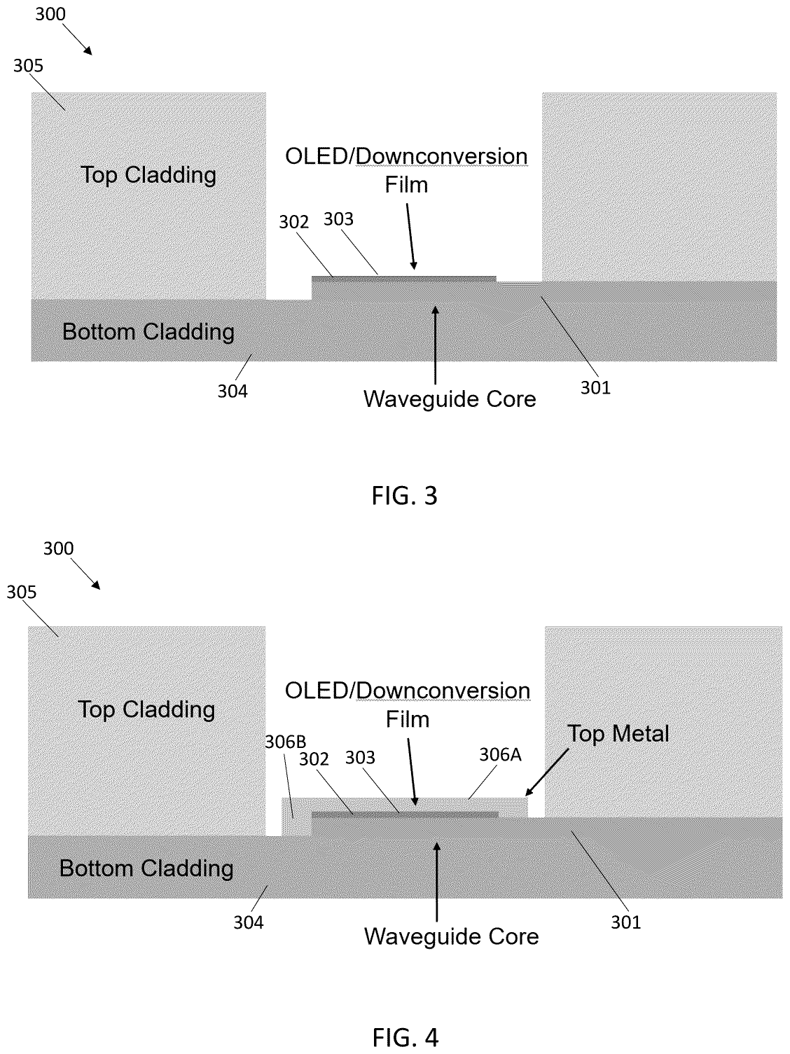

Several possibilities exist for increasing the coupling efficiency of OLEDs to waveguides, either single mode or multi-mode, by integrating thin-film deposition with silicon photonic platforms. These are illustrated in FIGS. 3-9, in order of increasing fabrication complexity and increasing expected coupling efficiency. These figures represent cross-sections of material stacks, and the OLED/Downconversion film and top film refer to thin-film stacks where a downconversion film is first deposited (to be as close as possible to the waveguide) followed by an OLED stack.

Referring now to FIGS. 3-9, exemplary light emitting devices are shown and described. In some embodiments, the device 300 is configured as an on-chip light source for a silicon photonic integrated circuit. In some embodiments, the device has an optical efficiency of at least 25%, at least 50%, at least 75%, or at least 95%.

As shown in FIGS. 3-9, each of the devices 300 may comprise a waveguide 301 with first 301A, second 301B, and/or third portions 301C. In some embodiments, the waveguide 301 can have a thickness of 1 nm to 15 μm and/or a width of 1 nm to 15 μm. In some embodiments, the first, second and third portions (301A-301C) comprise first, second and third materials. In some embodiments, the first, second, and third materials comprise a polymer, silicon, silicon nitride, lithium niobate, BTO, or other suitable material or combination thereof. In some embodiments, the waveguide includes incorporated downconversion materials allowing for light to be directly emitted from within the waveguide. In some embodiments, the waveguide 301 has an index of refraction in the range of 1.4-3.5. In some embodiments, one portion of the waveguide (301A-301C) can have a larger, smaller, or identical index of refraction as at least one of the other portions (301A-301C). In some embodiments, one or more sections of the waveguide 301 or one or more sections of portions of the waveguide (301A-301C) may be tapered in the vertical direction. In some embodiments, one or more sections of the waveguide 301 or one or more sections of portions of the waveguide (301A-301C) may be tapered in the horizontal direction. In some embodiments, a tapered section can be a forward taper where the larger end of the taper is proximate to the device 300 and the smaller end of the taper is remote to the device 300. In some embodiments, a tapered section can be a reverse taper where the smaller end of the taper is proximate to the device 300 and the larger end of the taper is remote to the device 300.

As shown in FIGS. 3-9, each of the devices 300 may comprise a downconverting thin-film stack 302 in optical communication with the waveguide 301. In some embodiments, the downconverting thin-film stack 302 is adjacent to the waveguide 301. In some embodiments, the downconverting thin-film stack 302 comprises a single layer, a multi-layer, and/or includes embedded elements such as quantum dots. In some embodiments, the downconverting thin-film stack 302 is configured to down convert light from the OLED thin-film stack 303 to a wavelength in the range of 1100 nm to 2400 nm. In some embodiments, the downconverting thin-film stack 302 has a thickness approximately equal to the thickness of the waveguide 301, and/or a width approximately equal to the width of the waveguide 301. In some embodiments, the downconverting thin-film stack 302 has a thickness of 1 nm to 15 μm and/or a width of 1 nm to 15 μm. In some embodiments, the downconverting thin-film stack 302 comprises a plurality of sub-layers comprising phosphorescent materials, quantum dots, or other suitable materials or combinations thereof.

In some embodiments, the downconverting thin-film stack 302 is replaced with downconversion materials, such as phosphors and/or quantum dots, incorporated directly into the waveguide 301. In such a case, the top film is simply an OLED thin-film stack 303 that supplies light to phosphors embedded within the waveguide 301.

In some embodiments, in addition to downconverting thin-film stack 302, downconversion materials, such as phosphors and/or quantum dots, are incorporated directly into the waveguide 301.

In some embodiments the downconverting thin-film stack 302 can be omitted. In such embodiment, light generated by the OLED thin-film stack 303 is directly coupled to the waveguide 301.

As shown in FIGS. 3-9, each of the devices 300 may comprise an OLED thin-film stack 303 in optical communication with the downconverting thin-film stack 302. In some embodiments, the OLED thin-film stack 303 is adjacent to the downconverting thin-film stack 302. In some embodiments, the OLED thin-film stack 303 comprises a single layer, a multi-layer, and/or includes embedded elements such as quantum dots. In some embodiments, the OLED thin-film stack 303 is configured to produce light in a wavelength within a range of 400 nm to 800 nm. In some embodiments, the OLED thin-film stack 303 has a thickness of 50 nm to 1000 nm. In some embodiments, the width, length, area, and/or volume of the OLED thin-film stack 303 match the waveguide size of the PIC. In some embodiments, the OLED thin-film stack 303 comprises a plurality of sub-layers as detailed above in FIGS. 1-2. In some embodiments, the OLED thin-film stack 303 comprises one or more hole injection layers, hole transporting layers, electron blocking layers, emission layers, hole blocking layers, electron transporting layers, and/or electron injection layers.

In some embodiments, the device 300 may include a microlens between the OLED thin-film stack 303 and the downconverting thin-film stack 302, and/or between the downconverting thin-film stack 302 and the waveguide 301, either in optical communication with and/or adjacent to the OLED thin-film stack 303, the downconverting thin-film stack 302, and/or the waveguide 301.

As shown in FIGS. 3-9, each of the devices 300 may comprise a bottom cladding layer 304 below the waveguide 301. In some embodiments, the bottom cladding layer 304 has a thickness of 0.5 μm to 10 μm, and can cover the entire area of the wafer and thus the whole area of the chip. In some embodiments, the bottom cladding layer 304 comprises SiO₂, or other suitable materials or combinations thereof. In some embodiments, the bottom cladding layer 304 comprises a stack of a plurality of sub-layers. In some embodiments, the bottom cladding layer 304 includes one or more metal layers. In some embodiments, the bottom cladding layer 304 comprises a DBR or similar reflector stack.

As shown in FIGS. 3-9, each of the devices 300 may comprise a top cladding layer 305 above the waveguide 301 and bottom cladding layer 304, and surrounding at least two sides of the downconverting 302 and OLED 303 thin-film stacks. In some embodiments, the top cladding layer 305 has a thickness of 0.5 μm to 10 μm, and covers the entire chip area except for where it has been patterned away. In some embodiments, the top cladding layer 305 comprises SiO₂, or other suitable materials or combinations thereof. In some embodiments, the top cladding layer 305 comprises a stack of a plurality of sub-layers. In some embodiments, the top cladding layer 305 includes one or more metal layers. In some embodiments, the top cladding layer 305 comprises a DBR or similar reflector stack.

Referring now to FIG. 3, an exemplary light emitting device 300 comprises a waveguide 301, a downconverting thin-film stack 302 in optical communication with the waveguide 301, and an OLED thin-film stack 303 in optical communication with the downconverting thin-film stack 302. The device 300 further includes a bottom cladding layer 304 below the waveguide 301, and a top cladding layer 305 above the waveguide 301 and bottom cladding layer 304, and surrounding at least two sides of the downconverting 302 and OLED 303 thin-film stacks. Further exemplary details of the waveguide 301, a downconverting thin-film stack 302, OLED thin-film stack 303, bottom cladding layer 304, and top cladding layer 305 are described above. In some embodiments, an oxide opening is provided above a silicon waveguide core and an OLED/downconversion film is directly deposited onto the core.

Referring now to FIG. 4, an exemplary light emitting device 300 comprises a waveguide 301, a downconverting thin-film stack 302 in optical communication with the waveguide 301, and an OLED thin-film stack 303 in optical communication with the downconverting thin-film stack 302. The device 300 further includes a bottom cladding layer 304 below the waveguide 301, and a top cladding layer 305 above the waveguide 301 and bottom cladding layer 304, and surrounding at least two sides of the downconverting 302 and OLED 303 thin-film stacks. Further exemplary details of the waveguide 301, a downconverting thin-film stack 302, OLED thin-film stack 303, bottom cladding layer 304, and top cladding layer 305 are described above. In some embodiments, the device 300 further includes a metal layer 306 on one side of the OLED thin-film stack 303. In some embodiments, the metal layer 306 layer is configured to reflect light from the OLED thin-film stack 303 to the downconverting thin-film stack 303 and into the waveguide 301. In some embodiments, the metal layer 306 encapsulates at least three sides of the OLED thin-film stack 303. In some embodiments, the metal layer 306 thick layer of metal is added on top of the film. This serves to reflect much of the light which is spontaneously emitted in a direction that will not couple to the waveguide mode, resulting in a much greater probability of reflecting or being re-absorbed and re-emitted into a useful direction. In some embodiments, the metal layer comprises a top portion 306A and a side portion 306B. In some embodiments, the metal layer 306 has a thickness of 10 nm to 1000 nm.

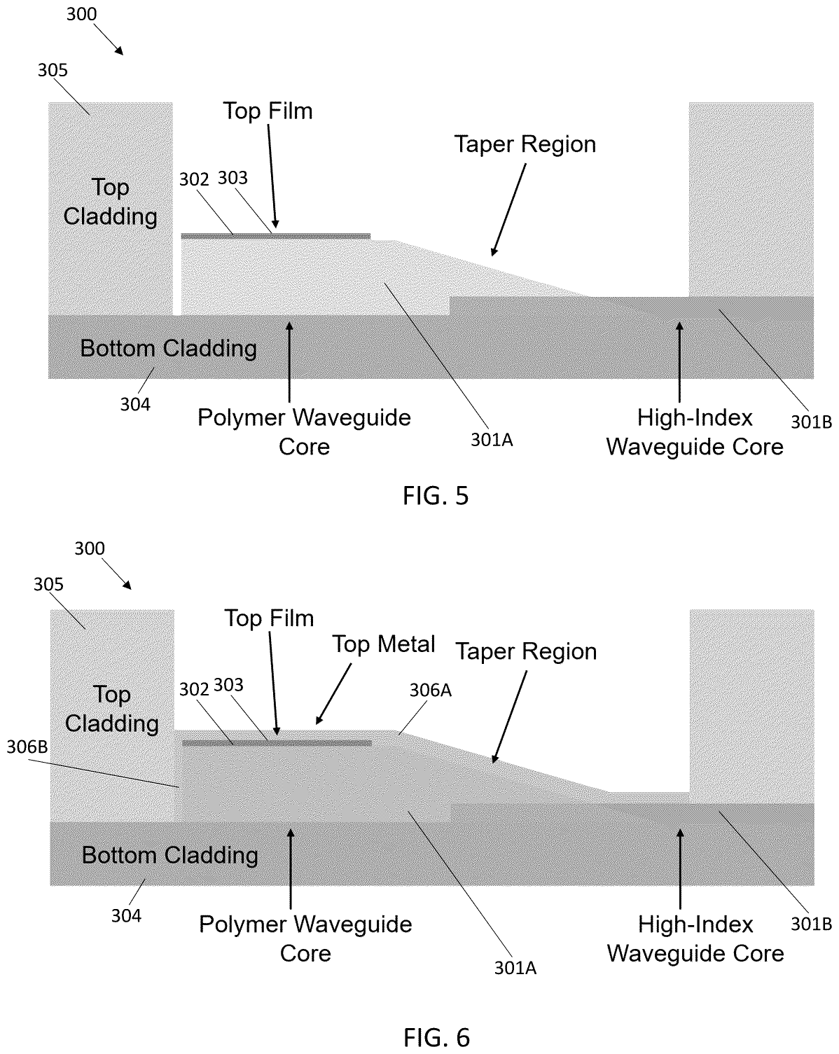

Referring now to FIG. 5, an exemplary light emitting device 300 comprises a waveguide 301 including first and second portions (301A, 301B), a downconverting thin-film stack 302 in optical communication with the waveguide 301, and an OLED thin-film stack 303 in optical communication with the downconverting thin-film stack 302. The device 300 further includes a bottom cladding layer 304 below the waveguide 301, and a top cladding layer 305 above the waveguide 301 and bottom cladding layer 304, and surrounding at least two sides of the downconverting 302 and OLED 303 thin-film stacks. Further exemplary details of the waveguide 301, a downconverting thin-film stack 302, OLED thin-film stack 303, bottom cladding layer 304, and top cladding layer 305 are described above. In some embodiments, the first portion of the waveguide 301A comprises a first material, and the second portion of the waveguide 301B comprises a second material which may be the same or different compared to the first material. In some embodiments, the first material comprises a polymer and the second material comprises silicon. In some embodiments, the index of refraction of the first material is smaller than, larger than, or equal to the index of refraction of the second material. In some embodiments the first portion of the waveguide 301A is at least partially tapered in the vertical direction. In some embodiments, the second portion of the waveguide 301B is not tapered in the vertical direction. In some embodiments, the polymer waveguide 301A is integrated into the oxide opening region and a taper in the polymer/silicon converts the single polymer waveguide mode to the single high-index silicon waveguide mode. Polymer has a lower refractive index than silicon, and therefore supports larger single-mode waveguides. This allows more area of the OLED/downconversion film (303, 302) to be deposited per unit length, ameliorating the inefficiency of coupling from spontaneously emitting sources.

Referring now to FIG. 6, an exemplary light emitting device 300 comprises a waveguide 301 including first and second portions (301A, 301B), a downconverting thin-film stack 302 in optical communication with the waveguide 301, and an OLED thin-film stack 303 in optical communication with the downconverting thin-film stack 302. The device 300 further includes a bottom cladding layer 304 below the waveguide 301, and a top cladding layer 305 above the waveguide 301 and bottom cladding layer 304, and surrounding at least two sides of the downconverting 302 and OLED 303 thin-film stacks. Further exemplary details of the waveguide 301, a downconverting thin-film stack 302, OLED thin-film stack 303, bottom cladding layer 304, and top cladding layer 305 are described above. In some embodiments, the first portion of the waveguide 301A comprises a first material, and the second portion of the waveguide 301B comprises a second material which may be the same or different compared to the first material. In some embodiments, the first material comprises a polymer and the second material comprises silicon. In some embodiments, the index of refraction of the first material is smaller than, larger than, or equal to the index of refraction of the second material. In some embodiments the first portion of the waveguide 301A is at least partially tapered in the vertical direction. In some embodiments, the second portion of the waveguide 301B is not tapered in the vertical direction. In some embodiments a metal layer 306 similar to as described above is positioned above and encapsulating at least three sides of the OLED thin-film stack 303. In some embodiments, the metal layer 306 is positioned above and encapsulating a non-vertically tapered section of the first portion of the waveguide 301A, a vertically tapered section of the first portion of the waveguide 301A, and at least one vertical side of the first portion of the waveguide 301A. In some embodiments, the metal layer 306 is positioned above a section of the second portion of the waveguide 301B. In some embodiments, the metal layer 306 is in contact with the vertically tapered section of the first portion of the waveguide 301A and with the section of the second portion of the waveguide 301B. In some embodiments, the metal layer 306 is deposited on top of the polymer and high-index waveguides (301A, 301B). This serves to reflect much of the light which is spontaneously emitted in a direction that will not couple to the waveguide mode, resulting in a much greater probability of reflecting or being re-absorbed and re-emitted into a useful direction.

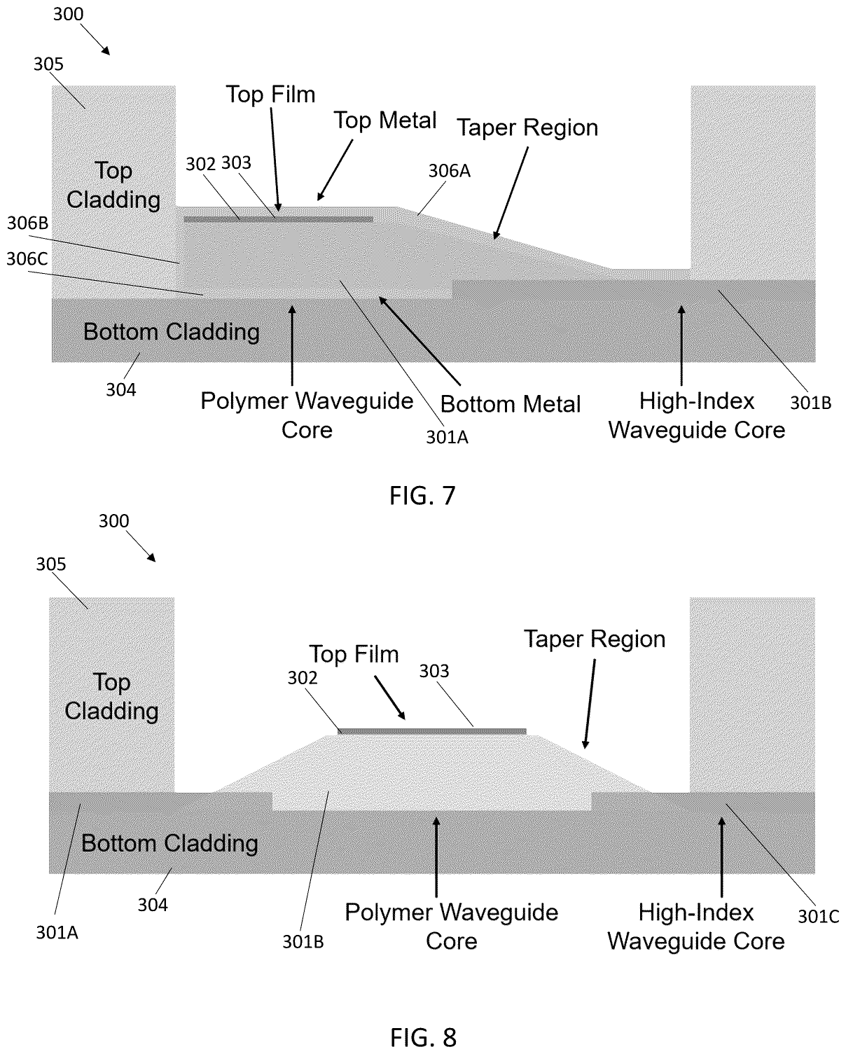

Referring now to FIG. 7, an exemplary light emitting device 300 comprises a waveguide 301 including first and second portions (301A, 301B), a downconverting thin-film stack 302 in optical communication with the waveguide 301, and an OLED thin-film stack 303 in optical communication with the downconverting thin-film stack 302. The device 300 further includes a bottom cladding layer 304 below the waveguide 301, and a top cladding layer 305 above the waveguide 301 and bottom cladding layer 304, and surrounding at least two sides of the downconverting 302 and OLED 303 thin-film stacks. Further exemplary details of the waveguide 301, a downconverting thin-film stack 302, OLED thin-film stack 303, bottom cladding layer 304, and top cladding layer 305 are described above. In some embodiments, the first portion of the waveguide 301A comprises a first material, and the second portion of the waveguide 301B comprises a second material which may be the same or different compared to the first material. In some embodiments, the first material comprises a polymer and the second material comprises silicon. In some embodiments, the index of refraction of the first material is smaller than, larger than, or equal to the index of refraction of the second material. In some embodiments the first portion of the waveguide 301A is at least partially tapered in the vertical direction. In some embodiments, the second portion of the waveguide 301B is not tapered in the vertical direction. In some embodiments a metal layer 306 similar to as described above comprises a top portion 306A, at least one side portion 306B, and a bottom portion 306C. In some embodiments, the top portion of the metal layer 306A is positioned above and encapsulating at least three sides of the OLED thin-film stack 303. In some embodiments, the top portion of the metal layer 306A is positioned above a non-vertically tapered section of the first portion of the waveguide 301A, and a vertically tapered section of the first portion of the waveguide 301A. In some embodiments, the side portion of the metal layer 306B encapsulates at least one vertical side of the first portion of the waveguide 301A. In some embodiments, the top portion of the metal layer 306A is positioned above a section of the second portion of the waveguide 301B. In some embodiments, the top portion of the metal layer 306A is positioned above a non-vertically tapered section of the second portion of the waveguide 301B. In some embodiments, the bottom portion of the metal layer 306C is between the first part of the waveguide 301A and a bottom cladding layer 304 to further increase efficiency. In some embodiments, the bottom portion of the metal layer 306C is adjacent to the second portion of the waveguide 301B.

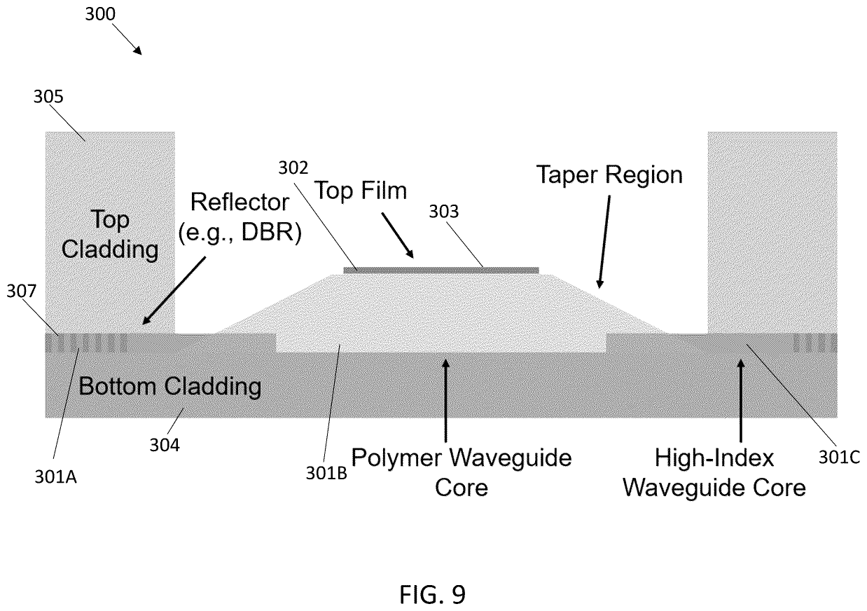

These light sources by themselves may have fewer desirable properties compared to laser sources. In order to mitigate this, similar structures to those described above may be used to instead amplify incoming light that is low power but has desirable communication properties. This can be done by mirroring any of the structures shown in FIGS. 3-7 such that there is an input waveguide in addition to an output waveguide. In this case, the downconversion film effectively becomes a gain medium pumped by visible-band OLEDs. A population inversion is required for this to work, so long upper-state lifetimes of the phosphor film and suitable pumping strength will be critical. Examples of this for the structure is described below and shown in FIGS. 8-9.

Referring now to FIGS. 8-9, an exemplary light emitting device 300 comprises a waveguide 301 including first, second, and third portions (301A, 301B, 301C), a downconverting thin-film stack 302 in optical communication with the waveguide 301, and an OLED thin-film stack 303 in optical communication with the downconverting thin-film stack 302. The device 300 further includes a bottom cladding layer 304 below the waveguide 301, and a top cladding layer 305 above the waveguide 301 and bottom cladding layer 304, and surrounding at least two sides of the downconverting 302 and OLED 303 thin-film stacks. Further exemplary details of the waveguide 301, a downconverting thin-film stack 302, OLED thin-film stack 303, bottom cladding layer 304, and top cladding layer 305 are described above. In some embodiments, the first and third portions of the waveguide (301A, 301C) comprise a first material, and the second portion of the waveguide 301B comprises a second material. In some embodiments, the first material comprises a polymer and the second material comprises silicon. In some embodiments, the index of refraction of the first material is smaller than the index of refraction of the second material. In some embodiments, the second portion of the waveguide 301B is vertically tapered in a first section, and vertically tapered in a second section opposite the first section. In some embodiments, as shown in FIG. 9 for example, the first portion and/or the third portion of the waveguide (301A, 301C) includes a reflector stack 307 such as a distributed Bragg reflector (DBR), a photonic crystal, a ring reflector, a racetrack reflector, a loop reflector, or other suitable reflector or combination thereof. In some embodiments, the device further includes a metal layer 306 positioned above and encapsulating at least three sides of the OLED thin-film stack 303. In some embodiments, the metal layer 306 is positioned above and encapsulating a majority of the second portion of the waveguide 301B including the tapered first and third sections. In some embodiments, the metal layer 306 is positioned above sections of the first and third portions of the waveguide (301A, 301C). In some embodiments, the first portion of the waveguide 301A is configured to receive light from a laser or other suitable light source.

Light of the correct wavelength coming in from one direction in the high-index core will be amplified through stimulated emission when the traveling optical wave interacts with the downconversion film so long as the downconversion film is in a population inversion. Any of the structures shown in FIGS. 3-7 can be extended in similar fashion. An additional way to improve optical quality of light generated by structures mentioned above is to add reflectors on either side of a structure such as described in FIG. 9, and by extension would work for any of the structures described in FIGS. 3-9. This would turn the whole structure into a quasi-3-level or quasi-4-level laser. Any of the structures described in FIGS. 3-7 that have been extended in the way can be effectively turned into a laser source by sandwiching the structure between two reflectors 307. These are shown here as distributed Bragg reflectors (DBRs) but other options work as well. In some embodiments, one of these reflectors will be strongly reflecting (transmittance close to zero) and one will be partially reflecting.

In some embodiments, an integrated photonic system comprises a downconverted OLED device, such as any of the devices 300 described above and shown in FIGS. 3-9, wherein the downconverted OLED stack is integrated with a silicon photonic chip or CMOS photonic chip. In some embodiments, the light is utilized for E-O phase or amplitude modulation, general purpose computation, interconnection switching, sensing, or other suitable operations or combinations thereof. In some embodiments, the system further includes a laser or other suitable light source in optical communication with the waveguide.

In some embodiments a product comprises the light emitting device as described above, where the product is selected from the group consisting of a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a sign, a full-stack optical platform, an optical interconnect, a high-speed optical interconnect, a MEMS device, an optical amplifier, an optical driver, a neuromorphic computer, a quantum computer, and a sensing device.

In some embodiments, a method for providing pump light for a silicon photonic integrated circuit comprises providing an integrated photonic system as described above, producing light via the OLED thin-film stack 303, downconverting the produced light via the downconverting thin-film stack 302, and guiding the downconverted light via the waveguide 301. In some embodiments, the method further comprises amplifying light received from a laser.

Combination with Other Materials

The materials described herein as useful for a particular layer in an organic light emitting device may be used in combination with a wide variety of other materials present in the device. For example, emissive dopants disclosed herein may be used in conjunction with a wide variety of hosts, transport layers, blocking layers, injection layers, electrodes and other layers that may be present. The materials described or referred to below are non-limiting examples of materials that may be useful in combination with the compounds disclosed herein, and one of skill in the art can readily consult the literature to identify other materials that may be useful in combination.

Various materials may be used for the various emissive and non-emissive layers and arrangements disclosed herein. Examples of suitable materials are disclosed in U.S. Patent Application Publication No. 2017/0229663, which is incorporated by reference in its entirety.

### Conductivity Dopants

A charge transport layer can be doped with conductivity dopants to substantially alter its density of charge carriers, which will in turn alter its conductivity. The conductivity is increased by generating charge carriers in the matrix material, and depending on the type of dopant, a change in the Fermi level of the semiconductor may also be achieved. Hole-transporting layer can be doped by p-type conductivity dopants and n-type conductivity dopants are used in the electron-transporting layer.

### HIL/HTL

A hole injecting/transporting material to be used in the present disclosure is not particularly limited, and any compound may be used as long as the compound is typically used as a hole injecting/transporting material.

### EBL

An electron blocking layer (EBL) may be used to reduce the number of electrons and/or excitons that leave the emissive layer. The presence of such a blocking layer in a device may result in substantially higher efficiencies, and or longer lifetime, as compared to a similar device lacking a blocking layer. Also, a blocking layer may be used to confine emission to a desired region of an OLED. In some embodiments, the EBL material has a higher LUMO (closer to the vacuum level) and/or higher triplet energy than the emitter closest to the EBL interface. In some embodiments, the EBL material has a higher LUMO (closer to the vacuum level) and or higher triplet energy than one or more of the hosts closest to the EBL interface. In one aspect, the compound used in EBL contains the same molecule or the same functional groups used as one of the hosts described below.

### Host

The light emitting layer of the organic EL device of the present disclosure preferably contains at least a metal complex as light emitting material, and may contain a host material using the metal complex as a dopant material. Examples of the host material are not particularly limited, and any metal complexes or organic compounds may be used as long as the triplet energy of the host is larger than that of the dopant. Any host material may be used with any dopant so long as the triplet criteria is satisfied.

### HBL

A hole blocking layer (HBL) may be used to reduce the number of holes and/or excitons that leave the emissive layer. The presence of such a blocking layer in a device may result in substantially higher efficiencies and/or longer lifetime as compared to a similar device lacking a blocking layer. Also, a blocking layer may be used to confine emission to a desired region of an OLED. In some embodiments, the HBL material has a lower HOMO (further from the vacuum level) and or higher triplet energy than the emitter closest to the HBL interface. In some embodiments, the HBL material has a lower HOMO (further from the vacuum level) and or higher triplet energy than one or more of the hosts closest to the HBL interface.

### ETL

An electron transport layer (ETL) may include a material capable of transporting electrons. The electron transport layer may be intrinsic (undoped), or doped. Doping may be used to enhance conductivity. Examples of the ETL material are not particularly limited, and any metal complexes or organic compounds may be used as long as they are typically used to transport electrons.

### Charge Generation Layer (CGL)

In tandem or stacked OLEDs, the CGL plays an essential role in the performance, which is composed of an n-doped layer and a p-doped layer for injection of electrons and holes, respectively. Electrons and holes are supplied from the CGL and electrodes. The consumed electrons and holes in the CGL are refilled by the electrons and holes injected from the cathode and anode, respectively; then, the bipolar currents reach a steady state gradually. Typical CGL materials include n and p conductivity dopants used in the transport layers.

As previously disclosed, OLEDs and other similar devices may be fabricated using a variety of techniques and devices. For example, in OVJP and similar techniques, one or more jets of material is directed at a substrate to form the various layers of the OLED.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

1. A light emitting device, comprising:
a waveguide;
a downconverting thin-film stack in optical communication with the waveguide; and
an OLED thin-film stack in optical communication with the downconverting thin-film stack.

2. The device of claim 1, wherein the device is configured as an on-chip light source for a silicon photonic integrated circuit.

3. The device of claim 1, further comprising:
a bottom cladding layer below the waveguide; and
a top cladding layer above the waveguide and bottom cladding layer, and
surrounding at least two sides of the downconverting and OLED thin-film stacks.

4. The device of claim 1, further comprising a metal layer on one side of the OLED thin-film stack, wherein the metal layer is configured to reflect light from the OLED thin-film stack to the downconverting thin-film stack.

5. (canceled)

6. The device of claim 4, wherein the metal layer encapsulates at least three sides of the OLED thin-film stack.

7. The device of claim 1, wherein the waveguide comprises a first portion comprising a first material, and a second portion comprising a second material, wherein the index of refraction of the first material is smaller than the index of refraction of the second material.

8. (canceled)

9. (canceled)

10. The device of claim 7, wherein the first portion of the waveguide is at least partially tapered in the vertical direction, and wherein the second portion of the waveguide is not tapered in the vertical direction.

11. (canceled)

12. The device of claim 7, further comprising:
a metal layer positioned above and encapsulating at least three sides of the OLED thin-film stack;
wherein the metal layer is positioned above and encapsulating a non-vertically tapered section of the first portion of the waveguide, a vertically tapered section of the first portion of the waveguide, and at least one vertical side of the first portion of the waveguide; and
wherein the metal layer is positioned above a section of the second portion of the waveguide.

13. (canceled)

14. The device of claim 7, further comprising:
a metal layer comprising a top portion, at least one side portion, and a bottom portion;
wherein the top portion of the metal layer is positioned above and encapsulating at least three sides of the OLED thin-film stack;
wherein the top portion of the metal layer is positioned above a non-vertically tapered section of the first portion of the waveguide, and a vertically tapered section of the first portion of the waveguide;
wherein the side portion of the metal layer encapsulates at least one vertical side of the first portion of the waveguide; and
wherein the top portion of the metal layer is positioned above a section of the second portion of the waveguide.

15. (canceled)

16. The device of claim 14, wherein the bottom portion of the metal layer is between the first part of the waveguide and a bottom cladding layer.

17. (canceled)

18. (canceled)

19. The device of claim 1, wherein the downconverting thin-film stack is configured to down convert light from the OLED thin-film stack to a wavelength in the range of 1100 nm to 2400 nm.

20. (canceled)

21. The device of claim 1, wherein the waveguide comprises a first and third portions comprising a first material, and a second portion comprising a second material and between the first and third portions.

22. (canceled)

23. The device of claim 21, wherein the index of refraction of the first material is smaller than the index of refraction of the second material.

24. The device of claim 21, wherein the second portion of the waveguide is vertically tapered in a first section, and vertically tapered in a second section opposite the first section.

25. The device of claim 21, wherein at least one of the first portion and the third portion of the waveguide includes a reflector stack.

26. The device of claim 21, further comprising:
a metal layer positioned above and encapsulating at least three sides of the OLED thin-film stack;
wherein the metal layer is positioned above and encapsulating a majority of the second portion of the waveguide including the tapered first and third sections; and
wherein the metal layer is positioned above sections of the first and third portions of the waveguide.

27. The device of claim 21, wherein the first portion of the waveguide is configured to receive light from a laser.

28. A product comprising the light emitting device of claim 1, the product selected from the group consisting of a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a sign, a full-stack optical platform, an optical interconnect, a high-speed optical interconnect, a MEMS device, an optical amplifier, an optical driver, a neuromorphic computer, a quantum computer, and a sensing device.

29. (canceled)

30. (canceled)

31. (canceled)

32. (canceled)

33. A light emitting device, comprising:
a waveguide with embedded downconversion materials; and
an OLED thin-film stack in optical communication with the waveguide.

34. A light emitting device, comprising:
a waveguide; and
an OLED thin-film stack in optical communication with the waveguide;
wherein the device is configured as an on-chip light source for a silicon photonic integrated circuit.

35. (canceled)

36. (canceled)

37. (canceled)

38. (canceled)

39. (canceled)

40. (canceled)

41. (canceled)
